(19) United States
(12) Patent Application Publication
(10) Pub. No.: US 2010/0283191 A1
(43) Pub. Date: Nov. 11, 2010

(54) PROCESS FOR PRODUCING RETARDATION FILM OF THERMOPLASTIC RESIN

(75) Inventors: Hiroaki Takahata, Ichihara-shi (JP); Yoshinori Takahashi, Ichihara-shi (JP); Kyoko Hino, Nerima-ku (JP)

Correspondence Address: SUGHRUE MION, PLLC, 2100 PENNSYLVANIA AVENUE, N.W., SUITE 800, WASHINGTON, DC, 20037, US

(73) Assignee: Sumitomo Chemical Company, Limited, Chuo-ku, Tokyo (JP)

(21) Appl. No.: 12/679,267

(22) PCT Filed: Sep. 18, 2008
(86) PCT No.: PCT/JP2008/066882

§ 371 Date: Jun. 4, 2010

(30) Foreign Application Priority Data
Sep. 21, 2007 (JP) 2007-245999

(51) Int. Cl. B29C 55/06

(52) U.S. Cl. 264/555

(57) ABSTRACT

The process has a step of longitudinally stretching a thermoplastic resin film F by heating and floating the thermoplastic resin film F by blowing hot wind supplied from slit 20a of each nozzle 20, and simultaneously, rotating nip rolls 30A, 30B, 32A, 32B at different rotation rates. Each slit 20a of the nozzle 20 extends in the width direction of the thermoplastic resin film F. Provided that, with respect to each slit of each nozzle, the product of the wind velocity of hot wind blown from the slit A (m/s) and the width of the slit B (m) is represented by C (m²/s), and the sum total of the products C of all the slits provided in a single nozzle is represented by Q, Q of each nozzle is 3×10⁻² m²/s or more and 1×10⁻¹ m²/s or less; and the wind velocity A of the hot wind blown from each slit is 2 m/s or more and 15 m/s or less.

### TECHNICAL FIELD

The present invention relates to a process for producing a retardation film of a thermoplastic resin.

### BACKGROUND ART

Retardation films of thermoplastic resins have been used in various fields. For example, in a display section of a liquid crystal display device, a stretched retardation film of a thermoplastic resin is used for improving a view angle. Generally, such a retardation film of a thermoplastic resin is disposed between a liquid crystal cell and a polarizing plate to form a phase difference due to difference in refractive index, thereby improving the view angle of a display section of a liquid crystal display device.

As a retardation film of a thermoplastic resin, a retardation film formed by stretching a film formed of a polycarbonate resin or a cyclic olefin based polymer resin is known (see, for example, Patent Document 1 and Patent Document 2). However, since these feedstock resins are expensive, development of a thermoplastic resin retardation film formed of an inexpensive plastic material has been desired.

For example, in Patent Document 3, a thermoplastic resin retardation film formed of a polyolefin resin is described. According to Patent Document 3, the retardation film is produced by longitudinally stretching a thermoplastic resin film between two or more rollers arranged in a length direction and rotated at different circumferential speeds and then, further transversely stretching it by a tenter method. Furthermore, Patent Document 4 discloses conditions for stretching various thermoplastic resin films prepared by a casting method.

Patent Document 1: Japanese Patent Application Laid-Open No. 07-256749

Patent Document 2: Japanese Patent Application Laid-Open No. 05-2108

Patent Document 3: Japanese Patent Publication No. 53-11228

Patent Document 4: Japanese Patent Application Laid-Open No. 11-142644

### DISCLOSURE OF THE INVENTION

However, a thermoplastic resin retardation film obtained by a conventional longitudinal stretching method is nonuniform in orientation in the film-width direction and, therefore, is uneven in phase difference and has optical axis irregularities. In addition, the film has many scratches and thus is not suitable for a retardation film.

An object of the present invention is to provide a process for producing a thermoplastic resin retardation film having few scratches and less variation of the optical axis and phase difference.

The present invention has a step of longitudinally stretching a thermoplastic resin film, in an oven having a pair of nozzle rows each having a plurality of nozzles, the rows being arranged to face each other with the nozzles positioned in a staggered configuration so that the nozzles may be arranged in a zigzag fashion, by heating and floating the thermoplastic resin film conveyed between the nozzle rows by blowing hot wind blown through a single or a plurality of slits of each nozzle to the thermoplastic resin film, and at the same time, by rotating, at different rotation rates, nip rolls which are arranged upstream from the oven and nip the thermoplastic resin film and nip rolls which are arranged downstream from the oven and nip the thermoplastic resin film.

In this step, the slit or slits of each nozzle extend in the width direction of the thermoplastic resin film. Provided that, with respect to each slit of each nozzle, the product of the wind velocity of hot wind blown from the slit A (m/s) and the width of the slit B (m) is represented by C (m²/s), and the sum total of the products C of all the slits provided in a single nozzle is represented by Q, Q of each nozzle is 3×10⁻² m²/s or more and 1×10⁻¹ m²/s or less; and the wind velocity A of hot wind blown from each slit is 2 m/s or more and 15 m/s or less.

It is preferred to longitudinally stretch the thermoplastic resin film to 1.5-fold or more and 3.0-fold or less.

Furthermore, it is preferred that the thermoplastic resin is a polyolefin based resin. It is particularly preferred that the polyolefin based resin is a polypropylene based resin.

### EFFECT OF THE INVENTION

According to the present invention, it is possible to obtain a thermoplastic resin retardation film having few scratches and having high axis accuracy and uniform phase difference. Furthermore, a retardation film produced by the process of the present invention is free of phase difference irregularities and optical axis irregularities derived from optical inhomogeneity even if it is used in a big-screen liquid crystal display of a big liquid crystal television, and therefore the retardation film has an excellent effect of improving view angle dependency. Moreover, the liquid crystal display device of the present invention, which has the retardation film having high axis accuracy and uniform phase difference, is excellent in view angle characteristics and durability.

### BRIEF DESCRIPTION OF THE DRAWINGS

FIG. 1 is a schematic sectional view of a longitudinal stretching machine according to an embodiment of the present invention; and

FIG. 2 is a schematic sectional view of the nozzle shown in FIG. 1.

### DESCRIPTION OF SYMBOLS

20 . . . nozzle, 20a . . . slit, 21 . . . nozzle row, 6 . . . oven, F . . . thermoplastic resin film, 30A, 30B, 32A, 32B . . . nip roll, 100 . . . longitudinal stretching machine.

### BEST MODES FOR CARRYING OUT THE INVENTION

Preferable embodiments of the present invention will be described below, if necessary, with reference to the drawings. In the descriptions about the drawings, reference symbols are used to designate like or equivalent structural elements and any further explanation is omitted for brevity's sake.

### (Thermoplastic Resin Film)

First, a thermoplastic resin film serving as a precursor film for use in a process for producing a retardation film of a thermoplastic resin according to an embodiment of the present invention will be described. A thermoplastic resin film according to the present invention is a flat film formed of a thermoplastic resin. Examples of the thermoplastic resin include a polyolefin based resin, a polycarbonate resin and a cyclic olefin based polymer resin.

In this embodiment, particularly a polyolefin based resin, which is excellent in cost performance, is preferred. The polyolefin based resin may be a blend of two or more different polyolefin based resins or may contain a resin other than the polyolefin based resin and an additive as long as the thermal characteristics of the polyolefin based resin described above may not be undermined.

Examples of the polyolefin based resin include a polypropylene based resin and a polyethylene based resin, and especially, a polypropylene based resin, which is excellent in cost performance, is preferred.

Examples of the polypropylene based resin of the this embodiment include a propylene homopolymer and a copolymer of propylene and at least one type of monomer selected from the group consisting of ethylene and an α-olefin having 4 to 20 carbon atoms, and a mixture of these.

Specific examples of the α-olefin include 1-butene, 2-methyl-1-propene, 1-pentene, 2-methyl-1-butene, 3-methyl-1-butene, 1-hexene, 2-ethyl-1-butene, 2,3-dimethyl-1-butene, 2-methyl-1-pentene, 3-methyl-1-pentene, 4-methyl-1-pentene, 3,3-dimethyl-1-butene, 1-heptene, 2-methyl-1-hexene, 2,3-dimethyl-1-pentene, 2-ethyl-1-pentene, 1-octene, 2-ethyl-1-hexene, 3,3-dimethyl-1-hexene, 2-propyl-1-heptene, 2-methyl-3-ethyl-1-heptene, 2,3,4-trimethyl-1-pentene, 2-propyl-1-pentene, 2,3-diethyl-1-butene, 1-nonene, 1-decene, 1-undecene, 1-dodecene, 1-tridecene, 1-tetradecene, 1-pentadecene, 1-hexadecene, 1-heptadecene, 1-octadecene and 1-nonadecene. Of the α-olefins, α-olefins having 4 to 12 carbon atoms are preferable.

Particularly in view of copolymerization properties, 1-butene, 1-pentene, 1-hexene and 1-octene are more preferable, and 1-butene and 1-hexene are further preferable.

The polypropylene based resin is preferably a propylene-ethylene copolymer or a propylene-1-butene copolymer. Furthermore, when the polypropylene based resin is a copolymer of at least one monomer selected from the group consisting of ethylene and an α-olefin having 4 to 20 carbon atoms and propylene, the copolymer may be either a random copolymer or a block copolymer.

Examples of the propylene based random copolymer include a propylene based random copolymer obtained by copolymerizing propylene and at least one α-olefin selected from the group consisting of ethylene and an α-olefin having 4 to 20 carbon atoms. Examples of the α-olefin having 4 to 20 carbon atoms include the aforementioned monomers, and more preferable examples include the aforementioned α-olefins having 4 to 12 carbon atoms.

Examples of the propylene based random copolymer include a propylene-ethylene random copolymer, a propylene-α-olefin random copolymer, and a propylene-ethylene-α-olefin random copolymer. More specifically, examples of the propylene-α-olefin random copolymer include a propylene-1-butene random copolymer, a propylene-1-hexene random copolymer, and a propylene-1-octene random copolymer. Examples of the propylene-ethylene-α-olefin random copolymer include a propylene-ethylene-1-butene random copolymer, a propylene-ethylene-1-hexene random copolymer, and a propylene-ethylene-1-octene random copolymer. Preferable examples thereof include a propylene-ethylene random copolymer, a propylene-1-butene random copolymer, a propylene-1-hexene random copolymer, a propylene-ethylene-1-butene random copolymer, and a propylene-ethylene-1-hexene random copolymer.

When the polypropylene based resin is a copolymer, the content of a structural unit derived from a comonomer in the copolymer is preferably more than 0 wt % and not more than 40 wt %, more preferably more than 0 wt % and not more than 30 wt %, and further preferably more than 0 wt % and not more than 10 wt %, in view of the balance between transparency and heat resistance. When the polypropylene based resin is a copolymer of two or more types of comonomers and propylene, the total content of structural units derived from all comonomers contained in the copolymer preferably falls within the aforementioned range.

The melt flow rate (MFR) of the polypropylene based resin, which is expressed by a value measured in accordance with JIS K7210 at a temperature of 230° C. and at a load of 21.18 N, generally falls within the range of 0.1 to 200 g/10 minutes, and preferably 0.5 to 50 g/10 minutes. By using a propylene based polymer having an MFR within such a range, drawdown of a film which may occur during longitudinal stretching and transverse stretching is reduced and a film tends to be uniformly stretched.

The molecular weight distribution of a polypropylene based resin is defined by the ratio of the weight average molecular weight (Mw) to the number average molecular weight (Mn) thereof and generally is 1 to 20. Mw and Mn are measured by GPC using o-dichlorobenzene of 140° C. as a solvent and polystyrene as a reference substance.

The melting point of a polypropylene based resin is generally 120 to 170° C. The melting point is defied by a temperature at which a peak of a maximum intensity appears in a melting curve obtained by measurement using a differential scanning calorimeter (DSC). The melting point is the melting peak temperature obtained by heating 10 mg of a pressed film of a polypropylene based resin under a nitrogen atmosphere at 230° C. for 5 minutes, followed by cooling to 30° C. at a temperature decreasing rate of 10° C./minute, maintaining at 30° C. for 5 minutes and further heating from 30° C. to 230° C. at a temperature raising rate of 10° C./minute.

The process for producing a polypropylene based resin include a process of polymerizing propylene alone using a known polymerization catalyst and a process of copolymerizing at least one monomer selected from the group consisting of ethylene and α-olefins having 4 to 20 carbon atoms and propylene. Examples of the known polymerization catalyst include

(1) a Ti—Mg based catalyst made of a solid catalyst component essentially containing magnesium, titanium and halogen, and so on;
(2) a catalyst made of a solid catalyst component essentially containing magnesium, titanium and halogen in combination with an organic aluminum compound, and if necessary, a third component, such as an electron-donating compound; and
(3) a metallocene catalyst.

As the catalyst system for use in producing a propylene based polymer, a catalyst system made of a solid catalyst component essentially containing magnesium, titanium and halogen in combination with an organic aluminum compound and an electron-donating compound can be used most generally among those mentioned above. More specifically, preferable examples of the organic aluminum compound include triethylaluminum, triisobutylaluminum, a mixture of triethylaluminum and diethylaluminium chloride and tetraethyldialumoxane. Preferable examples of the electron-donating compound include cyclohexyl ethyl dimethoxy silane, tert-butyl-n-propyl dimethoxy silane, tert-butyl ethyl dimethoxy silane and dicyclopentyl dimethoxy silane. Examples of the solid catalyst component essentially containing magnesium, titanium and halogen include the catalyst systems described in Japanese Patent Application Laid-Open Nos. 61-218606, 61-287904 and 7-216017. Examples of the metallocene catalyst include the catalyst systems described in Japanese Patent Nos. 2587251, 2627669 and 2668732.

A polymerization process for producing a polypropylene based resin includes a solvent polymerization method using an inert solvent represented by a hydrocarbon compound such as hexane, heptane, octane, decane, cyclohexane, methylcyclohexane, benzene, toluene and xylene; a bulk polymerization method using a liquid monomer as a solvent; and a vapor phase polymerization method performed in a gaseous monomer. Of them, the bulk polymerization method or the vapor-phase polymerization method is preferable. These polymerization methods may be performed in either a batch process or a continuous process.

The stereoregularity of a polypropylene based resin may be of any mode of isotactic, syndiotactic and atactic. In view of heat resistance, the polypropylene based resin is preferably a syndiotactic or isotactic propylene based polymer.

The polypropylene based resin may be a blend of two or more polypropylene based polymers different in molecular weight, ratio of a structural unit derived from propylene and tacticity, and may contain a polymer other than a polypropylene based polymer and an additive.

Examples of the additive that a polypropylene based resin can contain include an antioxidant, a UV ray absorbent, an antistatic agent, a lubricant, a nucleating agent, an anticlouding agent and an antiblocking agent. Examples of the antioxidant include a phenol based antioxidant, a phosphorus based antioxidant, a sulfur based antioxidant, a hindered amine based antioxidant (HALS) and a complex-type antioxidant, which has a unit having a phenol based antioxidation mechanism and a phosphorus based antioxidation mechanism in a single molecule. Examples of the UV ray absorbent include a UV ray absorbent such as a 2-hydroxy benzophenone based absorbent and a hydroxy triazole based absorbent and a UV ray blocking agent such as a benzoate based blocking agent. Examples of the antistatic agent include a polymer antistatic agent, an oligomer antistatic agent and a monomer antistatic agent. Examples of the lubricant include a higher fatty acid amide such as erucamide and oleic amide, a higher fatty acid such as stearic acid and a metal salt thereof. Examples of the nucleating agent include a sorbitol based nucleating agent, an organic phosphate based nucleating agent and a polymer nucleating agent such as polyvinyl cycloalkane. As the antiblocking agent, inorganic and organic microparticles of spherical shape or nearly spherical shape can be used. The aforementioned additives can be used in combination with two or more types.

As the thermoplastic resin film, optically homogeneous and non-oriented or nearly non-oriented film is preferably used. Specifically, a film having an in-plane phase difference of 30 nm or less is preferably used. As a process for producing a thermoplastic resin film, extrusion molding is preferred in view of production cost of the thermoplastic resin film. In the extrusion molding method, a thermoplastic resin is melted and kneaded in an extruder, extruded from a T-shaped die, brought into contact with a roll and taken up while cooling and solidifying. The film produced by the method is directly used as the thermoplastic resin film in the process of the present invention.

In producing a thermoplastic resin film by a T-shaped die extrusion molding method, examples of a process for cooling and solidifying a molten material extruded from a T-shaped die include a cooling method of using a casting roll and an air chamber, a method of nipping the material between a casting roll and a touch roll and pressurizing it, a method of nipping the material between a casting roll and an metallic endless belt which is provided in pressure contact with the casting roll along the circumferential direction of the casting roll, and pressuring it. When a casting roll is used for cooling, the surface temperature of the casting roll is preferably −15 to 30° C., and more preferably −15 to 15° C. in order to obtain a retardation film further excellent in transparency.

When a thermoplastic resin film is produced by the method of nipping a material between a casting roll and a touch roll and pressuring it, it is preferable to use, as the touch roll in order to obtain a nearly non-oriented thermoplastic resin film, a rubber roll or a roll having an outer cylinder formed of an elastically deformable metallic endless belt and a roll formed of a flexibly deformable elastic material within the outer cylinder with the space between the outer cylinder and the elastic roll filled with a temperature controlling medium.

When a rubber roll is used as the touch roll, in order to obtain a retardation film having a mirror surface, the molten material extruded from the T-shaped die is preferably nipped between the casting roll and the rubber roll and pressed together with a support. The support is preferably a biaxially stretched film of a thermoplastic resin having a thickness of 5 to 50 μm is preferred.

When a thermoplastic resin film is molded by the method of nipping the material between a casting roll and an metallic endless belt which is provided in pressure contact with the casting roll along the circumferential direction of the casting roll, and pressuring it, the endless belt is preferably held by a plurality of rolls arranged along the circumferential direction of the casting roll and in parallel to the casting roll. More preferably, the endless belt is held by two rolls having a diameter 100 to 300 mm and has a thickness of 100 to 500 μm.

To obtain a retardation film excellent in optical homogeneity, the thermoplastic resin film to be subjected to stretching preferably has a small thickness variation. The difference between the maximum thickness and the minimum thickness of the thermoplastic resin film is preferably 10 μm or less, and more preferably 4 μm or less.

### (Stretching Step)

In this embodiment, the thermoplastic resin film serving as a precursor film obtained in the aforementioned method or the like is subjected only to longitudinal stretching or subjected sequentially to longitudinal stretching and transverse stretching to obtain a thermoplastic resin retardation film. When stretching is performed sequentially, longitudinal stretching may be performed first and followed by transverse stretching, or transverse stretching may be performed first and followed by longitudinal stretching

### (Longitudinal Stretching Step)

In longitudinal stretching step of this embodiment, the thermoplastic resin film is longitudinally stretched by a so-called long span stretching method.

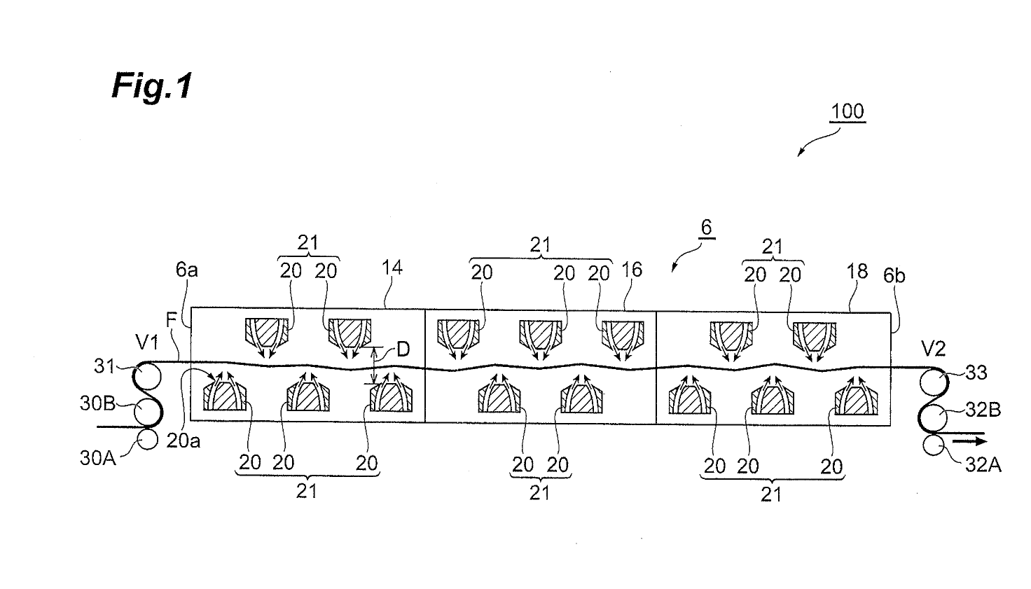

FIG. 1 is a schematic sectional view showing a longitudinal stretching step by the long span stretching method according to this embodiment.

In the long span stretching method is used a longitudinal stretching machine 100 which mainly has inlet-side nip rolls 30A, 30B located at the upstream side and outlet-side nip rolls 32A, 32B located at the downstream side and an oven 6 having a plurality of nozzles 20, the oven being arranged between these nip rolls.

A thermoplastic resin film F is nipped by the inlet-side nip rolls 30A, 30B and then conveyed, preferably via a roll 31, for example, horizontally in the oven 6 from the inlet 6a of the oven 6. Thereafter, the thermoplastic resin film F is discharged from the outlet 6b of the oven 6, nipped by the outlet-side nip rolls 32A, 32B and then sent to the following step, preferably via a roll 33. The film is preferably conveyed horizontally; however, it may be conveyed vertically or obliquely.

As a nip roll, a roll having a rubber layer or the like formed on the surface, and a metal roll can be used.

The oven 6 is partitioned principally into three zones, namely a preheating zone 14, a stretching zone 16 and a heat setting zone 18, whose temperatures can be each independently controlled, in this order from the upstream side. To feed the thermoplastic resin film F sequentially to the preheating zone 14, in which the film is principally preheated, the stretching zone 16, in which the film is principally longitudinally stretched, and the heat setting zone 18, in which the film longitudinally stretched is maintained at a prescribed temperature for a prescribed time to thereby effectively improve the stability of optical characteristics such as phase difference and optical axis, the thermoplastic resin film F is spanned between the inlet-side nip rolls 30A, 30B and the outlet-side nip rolls 32A, 32B. The oven 6 may be partitioned into four or more zones, or not more than two zones or a single zone.

In each of the zones 14, 16 and 18 of the oven 6, a pair of nozzle rows 21, 21 each having a plurality of nozzles 20 are arranged so as to face each other with the thermoplastic resin film F interposed between them. Specifically, the nozzle rows 21 facing each other are arranged in a staggered configuration along the longitudinal direction (moving direction) of the thermoplastic resin film F so that the nozzles 20 may be arranged in a zigzag fashion.

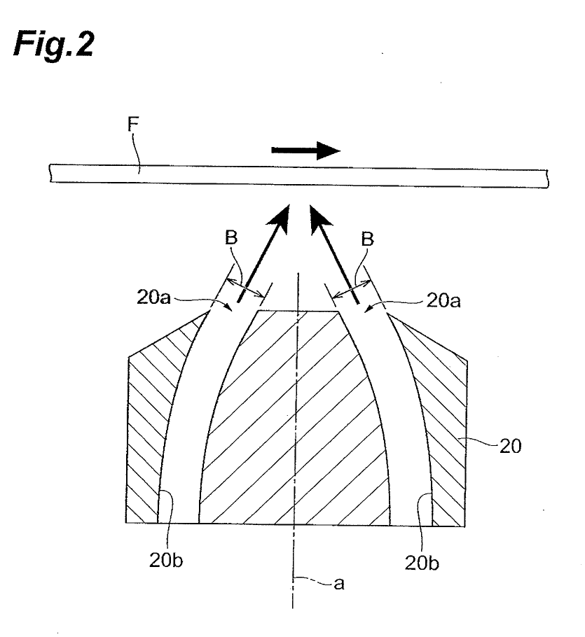

As shown in FIG. 2, each nozzle 20 has, at the tip thereof, a pair of slits 20a (serving as a hot wind blowout port), which are arranged at a distance in the longitudinal direction of the film with symmetric axis “a” of the nozzle 20 interposed between them. Furthermore, each slit 20a extends in the width direction of the thermoplastic resin film (direction perpendicular to the plane of the paper in FIG. 2) and has an opening at the top. A channel 20b, which supplies hot wind to each slit 20a, is formed such that it extends from a position apart from the symmetric axis “a” and curves so as to come closer to the symmetric axis “a” to reach the slit 20a. Hot wind obliquely discharges from each of the slits 20a such that hot wind comes closer to the symmetric axis “a”. These two gas streams are merged and blown to the film F substantially perpendicularly. The symmetric axis “a” is arranged substantially in perpendicular to the film F. Here, as shown in FIG. 2, in the plane perpendicular to the length direction of the slit 20a (the direction perpendicular to the plane of the paper of FIG. 2), the width of an opening of the slit 20a in a direction perpendicular to a direction along which a gas is blown from the slit 20a flows is defined as the slit width B. Furthermore, at a position located upstream from the channels 20b, gas supply pipes (not shown in the figure) for supplying hot wind are individually connected.

The longitudinal stretching step according to this embodiment will be described. The thermoplastic resin film F is first nipped between the upstream-side nip rolls 30A, 30B and preferably turned in direction by the roll 31 and passed though the preheating zone 14, the stretching zone 16 and the heat setting zone 18 of the oven 100. In each zone, the film F is heated by hot wind (for example, air) supplied from the slits 20a of a plurality of the nozzles 20 and simultaneously floated by the hot wind in the air. Thereafter, the thermoplastic resin film F discharged from the oven 6 is preferably turned in direction by the roll 33, nipped between downstream-side nip rolls 32A, 32B and then fed to the following step. At this time, the rotation rates of the outlet-side nip rolls 32A, 32B are set to be faster than those of the inlet-side nip rolls 30A, 30B, thereby applying stress to the film F in a longitudinal direction. In this manner, the thermoplastic resin film heated can be longitudinally stretched.

When the wind velocity and the amount of hot wind to be blown from the slit 20a of the nozzle 20 to the precursor film F in the oven 6 are extremely high or low, thermoplastic resin film F is not uniformly heated or widely flattered up and down. If so, it was found that the orientation due to stretching tends to be nonuniform, thereby producing variation of phase difference and variation of the optical axis. In addition, the thermoplastic resin film comes to be in contact with the nozzles and scratches are produced. Accordingly, to avoid such a state, the wind velocity and supply amount of hot wind must be controlled to fall within a specific range. Particularly, a polypropylene based resin film, unlike a material for a retardation film known in the art such as a polycarbonate resin and a cyclic olefin based polymer resin, has a low film-tension at a temperature at which a film can be stretched. Therefore, such a problem becomes significant.

Furthermore, in this embodiment, each wind velocity A of hot wind blown from single slit 20a of the nozzle 20 is set to 2 m/s or more and 15 m/s or less. The wind velocity is preferably 2 to 11 m/s in view of obtaining a retardation film having further excellent optical homogeneity. Furthermore, provided that the product of the wind velocity of hot wind blown from the slit 20a, A (m/s) and the slit width of the slit 20a, B (m), is represented by C (m²/s); and the sum of products C at all slits provided to the individual nozzles 20 is represented by Q, Q is adjusted to 3×10⁻² (m²/s) or more and 1×10⁻¹ (m²/s) or less. All slits 20a satisfy the requirement for the wind velocity A, and all nozzles 20 satisfy the requirement for Q.

By limiting the wind velocity A, slit width B, product C and the sum Q of products C, a retardation film sufficiently reduced in variation of thickness and variation of phase difference can be easily produced.

The reason why such effects can be obtained by limiting the wind velocity A, slit width B, product C and the sum Q of products C is not elucidated. However, the reason can be considered as follows. The product C corresponds to the flow rate of hot wind supplied from each slit of each nozzle per unit length in the film-width direction; and the sum Q of products C corresponds to the flow rate of hot wind supplied from each nozzle per unit length of the film in the width direction. From this, the flow rate and the wind velocity are specified within appropriate ranges. When the wind velocity A and the sum Q of products C are extremely low, the film cannot be sufficiently and stably fixed in the middle between the nozzle rows 21. As a result, the feeding position of the film is likely to vary and temperature is likely to change. As a result, a significantly large variation of phase difference may occur. On the other hand, when the wind velocity A and the sum Q of products C are excessively high, the flattering of the film tends to occur, and the film comes into contact with the nozzle. As a result, scratches are conceivably produced in the film and variation of the optical axis may occur.

The wind velocity A can be measured, for example, by using a hot wire anemometer (Anemomaster). Specifically, for example, the wind velocity of the hot wind blown from the slit 20a of the nozzle 20 is obtained as an average of the measurement values measured by a hot wire anemometer, which are obtained at five points in total of the slit 20a of the nozzle 20, two points of which are positioned at a distance of 100 mm from both ends of the film in the width direction, and three points of which are determined by equally dividing the interval between the two points into three.

The wind velocity of hot wind blown from the slit 20a of each nozzle 20 has a difference between a maximum rate and a minimum rate in the film-width direction, which is preferably 2 m/s or less, and more preferably 1 m/s or less.

The slit width B of the slit 20a is not particularly limited; however, it is preferably 3 mm or more, and more preferably 3 mm or more and 8 mm or less.

The distance between the nozzles 20 of each nozzle row 21 is not particularly limited; however, it is preferably from about 300 to 600 mm.

In the oven 6, the interval D between the upper end of each nozzle 20 of the lower nozzle row 21 and the lower end of each nozzle 20 of the upper nozzle row 21 is preferably 40 mm or more. By virtue of this, the film F more rarely comes into contact with each nozzle 20 and a retardation film having few scratches can be obtained. The interval D is preferably set to 150 mm or less, and more preferably, to 100 mm or less. By virtue of this, the position of the film can be fixed in the middle between the nozzle rows 21.

The stretching temperature of the thermoplastic resin film F (specifically, the atmospheric temperature of the oven 6) may be appropriately selected depending upon the thermoplastic resin contained in the thermoplastic resin film F and is thus not particularly limited. When the thermoplastic resin contained in the thermoplastic resin film F is an amorphous resin, the stretching temperature preferably falls within the temperature range of (Tg−20) to (Tg+30)° C. of the thermoplastic resin. On the other hand, when the thermoplastic resin is a crystalline resin, the stretching temperature preferably falls within the temperature range of (Tm−100) to (Tm+10)° C. of the thermoplastic resin. Tg represents a glass transition temperature and Tm represents a melting point. When the oven is partitioned into 2 or more zones, the temperature setting of individual zones may be the same or different. The temperature of the hot wind blown from the slit 20a of each nozzle 20 is set such that the temperature of each zone is a prescribed temperature.

Furthermore, to obtain a uniform orientation of the film in the width direction to impart high optical axis accuracy and uniform phase difference in the film-width direction, the temperature of the hot wind blown from the slit 20a of the nozzle 20 has a difference between a maximum temperature and a minimum temperature in the film-width direction, preferably, within 2° C. or less, and more preferably 1° C. or less. It is preferable that the hot wind have the above temperature difference at any temperature. At least, when the polypropylene based resin film is stretched, the hot wind preferably has the above temperature difference at any temperature from 80° C. or more and 170° C. or less.

The temperature of hot wind can be measured by a thermocouple arranged just proximal to the slit 20a. The measuring positions may, like the points at which the wind velocity of the hot wind from the nozzle is measured, for example, be 5 points in total in the film-width direction. The difference between a maximum temperature and a minimum temperature of the 5 points may be controlled to 2° C. or less.

Since the retardation film is used by being installed into a liquid crystal display device, the film must be free of attachment of a foreign substance and the like. For this purpose, the cleanliness factor of the oven 6 is preferably set to an air cleanliness class of 1000 or less. The “air cleanliness class” refers to the air cleanliness class defined by the USA Federal Standard (USA FED. STD) 209D. The “air cleanliness class of 1000” means the atmosphere whose content of microparticles having a particle diameter 0.5 μm or less is not more than, 1000/ft³. The air cleanliness class of 1000 defined by the USA Federal Standard 209D corresponds to air cleanliness class 6 defined by JIS B 9920, “evaluation method of air cleanliness in a clean room”.

The longitudinal stretching ratio is not particularly limited; however, it is generally 1.01 to 3.0-fold. In view of obtaining a retardation film having excellent optical homogeneity, the longitudinal stretching ratio is preferably 1.5 to 3-fold.

The rotation rate of the inlet-side nip rolls in longitudinal stretching is not particularly limited; however, it is preferred to be generally 1 to 20 m/minute. To obtain a retardation film having excellent optical homogeneity, the rotation rate is more preferably 3 to 10 m/minute.

The whole length of the oven used in longitudinal stretching in the film-length direction is not particularly limited; however, it is generally 1 to 15 m. To obtain a retardation film having excellent optical homogeneity, the whole length is preferably 2 to 10 m.

The total number of nozzles per zone is not limited; however, it is generally 5 to 30, and preferably 8 to 20. When the number of nozzles is excessively large, the curvature of a floating film becomes excessively large. On the other hand, when the number of nozzles is extremely small, the film cannot float in the middle of the nozzles. Both cases are not preferable.

The number of slit 20a per nozzle 20 is not limited to 2, may be 1 or 3 or more. The channel 20b reaching the nozzle 20a is not necessary curved and may be formed straight.

### (Transverse Stretching Step)

As a transverse stretching method, a tenter method is mentioned. In the tenter method, the film is fixed by chucks at both ends in the film width direction and stretched by increasing the interval between the chucks in an oven. The tenter method employs an apparatus having an oven having a preheating zone, a stretching zone, a heat setting zone the temperatures of which can be independently controlled. The transverse stretching ratio is generally, 2 to 10-fold. In view of obtaining high optical homogeneity of the resultant retardation film, the stretching ratio is preferably 4 to 7-fold.

The preheating step of the transverse stretching is a step performed before the step of stretching the thermoplastic resin film in the width direction. In this step, the film is heated to a high temperature sufficient to be stretched. In the preheating step, the preheating temperature means the atmospheric temperature of the zone of the oven, in which the preheating step is carried out. When the film to be stretched is formed of a polypropylene based resin, the preheating temperature may not be less than the melting temperature of a polypropylene based resin or not more than the melting point. In this case, to improve the uniformity of the phase difference of the resultant retardation film, generally, the preheating temperature is preferably set within the range from a temperature lower by 10° C. than the melting point of the polypropylene based resin, to a temperature higher by 10° C. than the melting point of the polypropylene based resin, and more preferably, from a temperature lower by 5° C. than the melting point of the polypropylene based resin, to a temperature higher by 5° C. than the melting point of the polypropylene based resin.

The stretching step of the transverse stretching is a step in which a film is stretched in the width direction. In the stretching step, the stretching temperature (this means the atmospheric temperature of the zone in the oven in which the stretching step is performed) may be lower than, higher than or equal to the preheating temperature. Generally, when the preheated film is stretched at a lower temperature than in the preheating step, the film can be uniformly stretched. As a result, a retardation film excellent in uniformity of phase difference can be obtained. Therefore, the stretching temperature is preferably lower by 5 to 20° C. than the preheating temperature of the preheating step, and more preferably lower by 7 to 15° C.

The heat setting step of the transverse stretching is a step in which the film is passed, while keeping the same film width as in the completion time of the stretching step, through an atmosphere of a prescribed temperature in the oven. The temperature of the heat setting step may be lower than or higher than or equal to the stretching temperature in the stretching step. Generally, to effectively improve the stability of optical characteristics of the film such as phase difference and optical axis, the temperature of the heat setting step preferably falls within the range of a temperature lower by 10° C. than the stretching temperature to higher by 30° C. than the stretching temperature.

The transverse stretching step may further have a thermal relaxation step. Generally in a tenter method, this step is performed in a thermal relaxation zone which is provided between the stretching zone and the heat setting zone and the temperature of which can be controlled independently of other zones or performed in the zone at which the heat setting step is carried out. Specifically, thermal relaxation is performed, after the film is stretched to a prescribed width in the stretching step, by narrowing the interval between chucks just by several % (generally, 0.1 to 10%), thereby removing useless distortion.

The phase difference required for a retardation film varies depending upon the type of a liquid crystal display device in which the retardation film is to be incorporated; however, generally, an in-plane phase difference R₀ is 30 to 300 nm. When the film is used in a vertical alignment mode liquid crystal display (described later), in view of obtaining excellent view angle characteristics, the in-plane phase difference R₀ is preferably 40 to 70 nm and the thickness-direction phase difference Rₜₕ is preferably 90 to 230 nm. The thickness of the retardation film is generally 10 to 100 μm and preferably 10 to 60 μm. By controlling the stretching ratio of a film in producing the retardation film and controlling the thickness of the resultant retardation film, it is possible to obtain a retardation film having a desired phase difference.

The in-plane phase difference R₀ and the thickness-direction phase difference Rₜₕ of a film are defined by the following expressions (I) and (II), respectively.

R₀=(nₓ−n_{y})×d (I)

Rₜₕ={(nₓ+n_{y})/2−n_{z}}×d (II)

In the expressions (I) and (II), nₓ is a refractive index in the slow axis direction in the film plane (the direction in which the refractive index becomes maximum). In the expressions (I) and (II), n_{y} is a refractive index in the fast axis direction in the film plane (the direction in which the refractive index becomes minimum). In the expression (II), n_{z} is a refractive index in the thickness-direction of the film. In the expressions (I) and (II), d is the thickness of the film expressed in the unit “nm”.

In the retardation film produced by the aforementioned method, the difference between the maximum and the minimum of the phase difference in the film plane (a plane 500 mm in width×500 mm in length) is 10 nm or less. When the angle of the optical axis (500 mm) of the film is measured in the width direction, the optical axis falls within the range of −1° to +1° and it is possible to obtain a retardation film having high optical homogeneity.

The optical axis used in this embodiment, refers to the azimuth direction in which the refractive index reaches a maximum in the plane of the stretched film, in short, the in-plane slow axis. The angle of the optical axis refers to the angle formed between the stretching direction of a polymer film and the in-plane slow axis of the polymer film and is sometimes called an orientation angle. In this embodiment, assuming that the stretching direction of a polymer film is regarded as a reference line (0°), the angle of the optical axis is defined by the angle formed between the in-plane slow axis and the reference line. The angle of the optical axis can be measured by a commercially available polarizing microscope or an automatic birefringence meter.

The retardation film of the present invention may be laminated together with various types of polarizing plates and liquid crystal layers and used preferably as liquid crystal display devices of mobile phones, personal digital assistants (PDA), personal computers and big-screen televisions, etc. Examples of the liquid crystal display device (LCD) in which the retardation film of the present invention is to be laminated and used include various-mode liquid crystal display devices, such as an optically compensated bend (OCB) mode, a vertical alignment (VA) mode, in-plane switching (IPS) mode, a thin film transistor (TFT) mode, a twisted nematic (TN) mode and a super twisted nematic (STN) mode devices. The liquid crystal display device is generally designed so that polarizing plates may be arranged on both sides of a liquid crystal cell having two substrates and a liquid crystal layer sandwiched therebetween, and of the beams emitted by a backlight disposed outside (rear-surface side) one of the polarizing plates, only a linearly polarized light beam, which proceeds in parallel to the transmission axis of the polarizing plate disposed between the liquid crystal cell and the backlight, can enter the liquid crystal cell. The retardation film of the present invention may be arranged between the rear-surface-side polarizing plate and a liquid crystal cell and/or between the front-surface-side polarizing plate and the liquid crystal cell via an adhesive agent. A polarizing plate generally has a configuration in which a polarizing film made of polyvinyl alcohol or the like is sandwiched between two protecting films, such as a triacetylcellulose (TAC) film, via an adhesive interposed therebetween in order to protect a polarizing film formed of polyvinyl alcohol. The retardation film of the present invention can be laminated to a polarizing film with an adhesive in place of the protecting film(s) located on the liquid crystal cell side of the front side and/or the rear side polarizing plate provided near the liquid crystal cell. If so, the retardation film of the present invention can serve as both an optical compensation film (retardation film) and a protecting film.

### EXAMPLES

The present invention will be more specifically described based on Examples; however, the present invention is not limited to these Examples in any way.

### (1) Melting Point

A polypropylene based resin was subjected to heat press molding to form a sheet having a thickness of 0.5 mm. In the heat press molding, a propylene based polymer was preheated in a heat press molding machine at 230° C. for 5 minutes. Thereafter, the polymer was pressurized for 3 minutes to a pressure of 50 kgf/cm², kept at the pressure for 2 minutes and pressed at 30 kgf/cm² while cooling at 30° C. for 5 minutes. The press sheet prepared was cut into pieces. The piece (10 mg) was subjected to measurement by a differential scanning calorimeter (DSC-7 type manufactured by PerkinElmer Co., Ltd.). More specifically, after the thermal hysteresis is added as shown in the following [1] to [5] under a nitrogen atmosphere, the pieces were heated from 50° C. to 180° C. at a temperature raising rate of 5° C./minute to form a melting curve. In the melting curve, the temperature (° C.) showing a maximum endothermic peak was obtained. This was defined as the melting point (Tm) of the propylene based resin.

[1] heating at 220° C. for 5 minutes;

[2] cooling at a temperature reducing rate of 300° C./minute from 220° C. to 150° C.;

[3] keeping the temperature at 150° C. for 1 minute;

[4] cooling at a temperature reducing rate of 5° C./minute from 150° C. to 50° C.;

[5] keeping the temperature at 50° C. for 1 minute.

### (2) Melt Flow Rate (MFR)

The melt flow rate was measured in accordance with JIS K7210 at a temperature of 230° C. and a load of 21.18N.

### (3) Ethylene Content

A propylene-ethylene copolymer was subjected to IR spectrum measurement described in “Polymer Analysis Handbook” (issued by KINOKUNIYA Company Ltd. 1995) on page 616 to obtain the content of a structural unit derived from ethylene in the copolymer.

### (4) Amount of Xylene Soluble Component

A sample (1 g) of a polypropylene based resin was completely dissolved in boiled xylene (100 ml). Thereafter, the sample was reduced in temperature to 20° C. and allowed to stand still at this temperature for 4 hours. After that, the sample was filtrated to fractionate into a precipitate and a filtrate. From the filtrate, xylene was distilled away to produce a solid substance, which was dried under reduced pressure at 70° C. The ratio of the remaining substance (weight) after dried relative to the weight (1 g) of the sample was determined as the amount of xylene soluble component (CXS) of the polypropylene based resin at 20° C.

(5) In-Plane Phase Difference R₀ and Variation of in-Plane Phase Difference

The in-plane phase difference R₀ was measured by use of a phase difference measurement apparatus (KOBRA-CCD manufactured by Oji Scientific Instruments) with respect to a longitudinally stretched film and a biaxial stretched film. The variation of in-plane phase difference of the longitudinally stretched film was obtained by measuring phase difference in the center (550 mm in width) of a longitudinally stretched film continuously in the width direction by a phase difference measuring apparatus. The difference ΔR₀ between a maximum value and a minimum value was divided by the average value of R₀ to obtain a variation of the in-plane phase difference. When the variation of in-plane phase difference is 5% or less, the uniformity of phase difference is satisfactory.

### (6) Thickness-Direction Phase Difference R_{Th}

Thickness-direction phase difference Rₜₕ was measured in the center portion of a retardation film by use of a phase difference measurement apparatus (KOBRA-WPR manufactured by Oji Scientific Instruments).

### (7) Angle of Optical Axis and Variation Thereof

Using a polarizing microscope, an angle of the optical axis was measured in the range of 500 mm in width of a longitudinally stretched film at intervals of 20 mm. The difference between a maximum value and a minimum value was determined as a variation of the optical axis. When the variation of the optical axis is 2° or less, the optical-axis uniformity is satisfactory.

### Example 1

A polypropylene based resin (propylene-ethylene random copolymer, Tm=136° C., MFR=8 g/10 minutes, ethylene content=5 wt %, CXS=4%) was loaded in a 65 mm φ extruder having a cylinder temperature of 200° C., melted, kneaded and extruded from a T-die of 1200 mm in width provided to the extruder at an extrusion amount of 65 kg/h. The molten polypropylene based resin extruded was nipped by a casting roll of 400 mm φ adjusted to a temperature of 12° C. and a touch roll consisted of an outer cylinder formed of metal sleeve adjusted to a temperature of 12° C. and an elastic roll placed inside the outer cylinder, and pressed to cool to obtain a polypropylene based resin film having a thickness of 90 μm and a width of 900 mm. The air gap was 115 mm, and the length of the pressing and sandwiching the molten polypropylene based resin between the casting roll and touch roll was 20 mm. The resultant polypropylene based resin film was introduced into a long-span longitudinal stretching machine shown in FIG. 1 and FIG. 2 having an air floating-system oven between two pairs of nip rolls and longitudinally stretched. The air floating-system oven was partitioned into 3 zones each having a length of 3 m. In each zone, 6 pairs of nozzles were arranged. The hot wind velocity A from each slit of the nozzles was 10 m/s, each slit width B of the nozzle was 2×10⁻³ m and the interval between the upper and lower nozzles was 40 mm. To a single nozzle, two slits having the same slit width were provided. The temperature of three zones were all set to 110° C. as the longitudinal stretching conditions, and inlet feed rate=5 m/minute and stretching ratio=2 fold were employed. During a longitudinal stretching process performed in these conditions, the film floated almost in the middle between the upper nozzles and lower nozzles in no contact with the nozzles and kept at a normal floating state.

The difference between a maximum hot wind velocity and a minimum hot wind velocity from a slit of a nozzle was 0.4 m/seconds. Furthermore, difference in temperature of the hot wind in the film-width direction was at most 0.8° C. The wind velocity and amount of hot wind and temperature difference thereof were values measured by the following methods.

### <Measurement of Hot Wind Velocity>

The wind velocity of the hot wind blown from a nozzle was measured as follows. In each of the upper and lower nozzles arranged near the center of each zone in the film-feed direction relative to the film moving direction, a pair of points were defined, which were positioned at a distance of 100 mm from both ends of each nozzle in the width direction toward the center of each nozzle. The interval between the pair of points was partitioned into four portions to define three partition points. At these five points in total, the wind velocity of hot wind was measured by a heat-wire anemometer. To describe more specifically, in each zone, the wind velocity of hot wind was measured by a commercially available hot-wire anemometer at 10 points in total in an upper nozzle and a lower nozzle. Subsequently, an average value of these was regarded as the hot wind velocity from each nozzle. Furthermore, the difference between a maximum wind velocity and a minimum wind velocity of the 10-point wind velocities is determined as a hot wind velocity difference in the film-width direction.

### <Determination of Temperature Difference of Hot Wind>

The temperature difference of hot wind from the nozzles was obtained by measurement as follows. In the same manner as in the aforementioned process for measuring a hot wind velocity, temperature was measured at total 10 points of the upper nozzle and the lower nozzle by a thermocouple. Of the temperature measurement data at the 10 points, the difference between a maximum temperature and a minimum temperature was obtained as the temperature difference of hot wind in the film-width direction.

The longitudinally stretched film had a thickness of 62 μm, a width of 650 mm, an in-plane phase difference R₀ in average was 850 nm, and a thickness-direction phase difference Rₜₕ was 470 nm. The variation of the in-plane phase difference was 3.2%, the variation of the optical axis was 1.0°. The longitudinally stretched film had good phase-difference uniformity and optical-axis uniformity. The number of scratches of the film surface was small.

The longitudinally stretched film was further transversely stretched by a tenter method to obtain a retardation film. The transverse stretching was performed in the conditions: the temperature of a preheating zone=141° C., temperature of a stretching zone=131° C., temperature of a heat setting zone=131° C. and a stretching ratio=3.5 fold.

The resultant retardation film was measured for R₀, Rₜₕ and optical axis accuracy. The average value R₀ was 70 nm, the difference between a maximum value and a minimum value of R₀ was 6 nm, Rₜₕ was 200 nm, and the angle of the optical axis was −0.5° or more and +0.5° or less. The retardation film had high optical homogeneity. The retardation film was laminated on the rear surface of a VA mode liquid crystal cell. More specifically, on the rear surface of the liquid crystal cell substrate, an adhesive agent, a retardation film, an adhesive agent and a polarizing plate are laminated in this order. On the front surface of the liquid crystal cell, an adhesive agent and a polarizing plate were laminated in this order. On the rear surface of the liquid crystal display device, a backlight was provided. The liquid crystal cell was evaluated under no voltage application (black display state) for view-angle dependency based on light leakage caused by change of a view angle. In the case where light leakage is low as viewed from any direction, view-angle dependency was low, demonstrating that the retardation film has excellent view-angle characteristics. The liquid crystal display device of this example, light leakage was low in the front direction and in an oblique direction. Thus, the view angle characteristics of the device were found to be excellent.

### Comparative Example 1

A longitudinally stretched film was prepared in the same manner as in Example 1 except that the hot wind velocity A from each slit of the nozzles of the long-span longitudinal stretching machine was set to 30 m/s. During longitudinal stretching performed in the conditions, the film floated almost in the middle between the upper and lower nozzles; however, the film widely flattered up and down and partly came into contact with a nozzle. The film had scratches.

The temperature difference of the hot wind supplied from a nozzle in the film-width direction was at most 0.9° C., and the difference in wind velocity was at most 1 m/s. Measurement of temperature and wind velocity and calculation of temperature difference and supply-rate difference were performed in the same manner as in Example 1.

The longitudinally stretched film had a thickness of 61 μm, a width of 650 mm, an in-plane phase difference R₀ in average of 860 nm and a thickness-direction phase difference Rₜₕ of 480 nm. The variation of the in-plane phase difference was 2.3% and the variation of the optical axis was 2.7°. The longitudinally stretched film had good phase-difference uniformity but the optical-axis uniformity was poor.

### Comparative Example 2

A longitudinally stretched film was prepared in the same manner as in Example 1 except that the hot wind velocity A from each slit of the nozzles of the long-span longitudinal stretching machine was set to 5 m/s. During longitudinal stretching performed in the conditions, the film did not float in the middle between the upper and lower nozzles but floated slightly near the lower nozzles. It was not a normal floating state. The temperature difference of the hot wind supplied from a nozzle in the film-width direction was at most 0.8° C., and the difference in wind velocity was at most 0.2 m/s. Measurement of temperature and wind velocity and calculation of temperature difference and supply-rate difference were performed in the same manner as in Example 1.

The longitudinally stretched film had a thickness of 63 μm, a width of 650 mm, an in-plane phase difference R₀ in average of 830 nm and a thickness-direction phase difference Rₜₕ of 440 nm. The variation of the in-plane phase difference was 6.8% and the variation of the optical axis was 0.5°. The longitudinally stretched film had good optical-axis uniformity but the phase-difference uniformity was poor. The results of Examples 1, 2 and Comparative Example 1 are shown in Table 1.

TABLE 1

| | | Comparative | Comparative |
|---|---|---|---|
| | Example 1 | Example 1 | Example 2 |
| Wind velocity A from nozzle | 10 | 30 | 5 |
| (m/s) | | | |
| Interval between upper and lower | 40 | 40 | 40 |
| nozzles (mm) | | | |
| Slit width B of nozzle (mm) | 2 | 2 | 2 |
| C = A × B (m²/s) | 0.02 | 0.06 | 0.01 |
| Number of slits per nozzle | 2 | 2 | 2 |
| Q (m²/s) | 0.04 | 0.12 | 0.02 |
| State of floating | Floated in the | Vigorously | Floated near in |
| | middle of upper | flattered and film | the lower nozzles: |
| | and lower | came into contact | Defective floating |
| | nozzles: normal | with nozzle | state |
| | floating state | | |
| Average R₀ (nm) | 850 | 860 | 830 |
| Variation of in-plane phase | 3.2 | 2.3 | 6.8 |
| difference (%) | | | |
| Variation of optical axis (°) | 1.0 | 2.7 | 0.5 |

### Example 2

A longitudinally stretched film was prepared in the same manner as in Example 1 except that the interval between upper and lower nozzles in the long-span longitudinal stretching machine was set to 70 mm and the temperatures of three zones were all set to 120° C. as the longitudinal stretching conditions. During longitudinal stretching performed in the conditions, the film floated almost in the middle between the upper and lower nozzles without being in contact with the nozzles. A normal floating state was maintained. The longitudinally stretched film had a thickness of 61 μm, a width of 650 mm, an in-plane phase difference R₀ in average of 850 nm and a thickness-direction phase difference Rₜₕ of 450 nm. The variation of the in-plane phase difference was 4.9% and the variation of the optical axis was 1.2°. The longitudinally stretched film had good phase-difference uniformity and optical-axis uniformity. The number of scratches in the film surface was small.

### Example 3

A longitudinally stretched film was prepared in the same manner as in Example 1 except that the thickness of the polypropylene based resin film used was set to 100 μm, the hot wind velocity A from each slit of the nozzles of the long-span longitudinal stretching machine was set to 5 m/s, the width B of each slit of the nozzles was set to 4×10⁻³ m and the interval between upper and lower nozzles was set to 70 mm. During longitudinal stretching performed in the conditions, the film floated almost in the middle between the upper and lower nozzles without being in contact with the nozzles. A normal floating state was maintained.

The temperature difference of hot wind from a nozzle in the film-width direction was at most 0.8° C., difference in wind velocity was at most 0.2 m/s. Measurement of temperature and wind velocity and calculation of temperature difference and supply-rate difference were performed in the same manner as in Example 1.

The longitudinally stretched film had a thickness of 74 μm, a width of 650 mm, an in-plane phase difference R₀ in average of 1120 nm and a thickness-direction phase difference Rₜₕ of 640 nm. The variation of the in-plane phase difference was 3.8%, the variation of the optical axis was 2.0°. The longitudinally stretched film had good phase-difference uniformity and optical-axis uniformity. The number of scratches in the film surface was small.

### Example 4

A longitudinally stretched film was prepared in the same manner as in Example 3 except that the temperatures of three zones were all set to 120° C. as the longitudinal stretching conditions. During longitudinal stretching performed in the conditions, the film floated almost in the middle position between the upper and lower nozzles without being in contact with the nozzles. A normal floating state was maintained.

The longitudinally stretched film had a thickness of 78 μm, a width of 650 mm, an in-plane phase difference R₀ in average of 1060 nm and a thickness-direction phase difference Rₜₕ of 590 nm. The variation of the in-plane phase difference was 5.0% and the variation of the optical axis was 1.9°. The longitudinally stretched film had good phase-difference uniformity and optical-axis uniformity. The number of scratches in the film surface was small.

### Example 5

A longitudinally stretched film was prepared in the same manner as in Example 1 except that the hot wind velocity A from each slit of the nozzles of the long-span longitudinal stretching machine was set to 5 m/s, the width B of each slit of the nozzles was set to 6×10⁻³ m, the interval between upper and lower nozzles was set to 70 mm and the temperatures of three zones were all set to 120° C. as the longitudinal stretching conditions. During longitudinal stretching performed in the conditions, the film floated almost in the middle between the upper and lower nozzles without being in contact with the nozzles. A normal floating state was maintained.

The longitudinally stretched film had a thickness of 61 μm, a width of 650 mm, an in-plane phase difference R₀ in average of 910 nm and a thickness-direction phase difference Rₜₕ of 400 nm. The variation of the in-plane phase difference was 4.0% and the variation of the optical axis was 1.1°. The longitudinally stretched film had good phase-difference uniformity and optical-axis uniformity. The number of scratches in the film surface was small. The results of Examples 2 to 5 are shown in Table 2.

TABLE 2

| | Example 2 | Example 3 | Example 4 | Example 5 |
|---|---|---|---|---|
| Wind velocity A from nozzle | 10 | 5 | 5 | 5 |
| (m/s) | | | | |
| Interval between upper and lower | 70 | 70 | 70 | 70 |
| nozzles (mm) | | | | |
| Slit width B of nozzle (mm) | 2 | 4 | 4 | 6 |
| C = A × B (m²/s) | 0.02 | 0.02 | 0.02 | 0.03 |
| Number of slits per nozzle | 2 | 2 | 2 | 2 |
| Q (m²/s) | 0.04 | 0.04 | 0.04 | 0.06 |
| State of floating | Floated in | Floated in | Floated in | Floated in |
| | the middle of | the middle of | the middle of | the middle of |
| | upper and | upper and | upper and | upper and |
| | lower | lower | lower | lower |
| | nozzles: | nozzles: | nozzles: | nozzles: |
| | normal | normal | normal | normal |
| | floating state | floating state | floating state | floating state |
| Average R₀ (nm) | 850 | 1120 | 1060 | 910 |
| Variation of in-plane phase | 4.9 | 3.8 | 5.0 | 4.0 |
| difference (%) | | | | |
| Variation of optical axis (°) | 1.2 | 2.0 | 1.9 | 1.1 |

### Comparative Example 3

A longitudinally stretched film was prepared in the same manner as in Comparative Example 2 except that the temperatures of three zones were all set to 120° C. as the longitudinal stretching conditions. During longitudinal stretching performed in the conditions, the film did not float in the middle between the upper and lower nozzles but floated slightly near the lower nozzles. It was not normal floating state. The longitudinally stretched film had a thickness of 63 μm, a width of 650 mm, an in-plane phase difference R₀ in average of 830 nm and a thickness-direction phase difference Rₜₕ of 450 nm. The variation of the in-plane phase difference was 9.5% and the variation of the optical axis was 1.5°. The longitudinally stretched film had good optical-axis uniformity but the uniformity of phase difference was poor.

### Comparative Example 4

A longitudinally stretched film was prepared in the same manner as in Example 1 except that the hot wind velocity A from each slit of the nozzles of the long-span longitudinal stretching machine was set to 15 m/s, the width B of each slit of the nozzles was set to 4×10⁻³ m, the interval between upper and lower nozzles was set to 70 mm and the temperatures of three zones were all set to 120° C. as the longitudinal stretching conditions. During longitudinal stretching performed in the conditions, the film floated almost in the middle between the upper and lower nozzles but the film vigorously flattered up and down. The temperature difference of the hot wind supplied from a nozzle in the film-width direction was at most 0.8° C., and the difference in wind velocity was at most 0.6 m/s. Measurement of temperature and wind velocity and calculation of temperature difference and supply-rate difference were performed in the same manner as in Example 1.

The longitudinally stretched film had a thickness of 62 μm, a width of 650 mm, an in-plane phase difference R₀ in average of 840 nm and a thickness-direction phase difference Rₜₕ of 420 nm. The variation of the in-plane phase difference was 3.4% and the variation of the optical axis was 2.7°. The longitudinally stretched film had good phase-difference uniformity but the optical-axis uniformity was poor. The results of Comparative Examples 3 and 4 are shown in Table 3.

TABLE 3

| | Comparative | Comparative |
|---|---|---|
| | Example 3 | Example 4 |
| Wind velocity A from nozzle | 5 | 15 |
| (m/s) | | |
| Interval between upper and lower | 40 | 70 |
| nozzles (mm) | | |
| Slit width B of nozzle (mm) | 2 | 4 |
| C = A × B (m²/s) | 0.01 | 0.06 |
| Number of slits per nozzle | 2 | 2 |
| Q (m²/s) | 0.02 | 0.12 |
| State of floating | Floated near the lower | Vigorously |
| | nozzles: defective | flattered |
| | floating state | |
| Average R₀ (nm) | 830 | 840 |
| Variation of in-plane phase | 9.5 | 3.4 |
| difference (%) | | |
| Variation of optical axis (°) | 1.5 | 2.7 |

1. A process for producing a retardation film of a thermoplastic resin, comprising:
a step of longitudinally stretching a thermoplastic resin film, in an oven having a pair of nozzle rows each having a plurality of nozzles, the rows being arranged to face each other with the nozzles positioned in a staggered configuration so that the nozzles may be arranged in a zigzag fashion, by heating and floating the thermoplastic resin film conveyed between the nozzle rows by blowing hot wind blown through a single or a plurality of slits of each nozzle to the thermoplastic resin film, and by rotating, at different rotation rates, nip rolls which are arranged upstream from the oven and nip the thermoplastic resin film and nip rolls which are arranged downstream from the oven and nip the thermoplastic resin film,
wherein, provided that, with respect to each slit of each nozzle, the product of the wind velocity of hot wind blown from the slit A (m/s) and the width of the slit B (m) is represented by C (m²/s), and
the sum total of the products C of all the slits provided in a single nozzle is represented by Q,
Q of each nozzle is 3×10⁻² m²/s or more and 1×10⁻¹ m²/s or less; and the wind velocity A of the hot wind blown from each slit is 2 m/s or more and 15 m/s or less.

2. The process for producing a retardation film of a thermoplastic resin according to claim 1, wherein the thermoplastic resin film is longitudinally stretched to 1.5-fold or more and 3.0-fold or less.

3. The process for producing a retardation film of a thermoplastic resin according to claim 1, wherein the thermoplastic resin is a polyolefin based resin.

4. The process for producing a retardation film of a thermoplastic resin according to claim 3, wherein the polyolefin based resin is a polypropylene based resin.
